(19) United States
(12) Patent Application Publication
(10) Pub. No.: US 2024/0259473 A1
(43) Pub. Date: Aug. 1, 2024

(54) DISTRIBUTED SERVERLESS RULE CONSEQUENCE EVALUATION FOR A CONTAINERIZED RULES ENGINE

(71) Applicant: Red Hat, Inc., Raleigh, NC (US)

(72) Inventors: Edoardo Vacchi, Milano (IT); Mario Fusco, Gorgonzola (IT); Daniele Zonca, Vignate (IT)

(21) Appl. No.: 18/162,483

(22) Filed: Jan. 31, 2023

(51) Int. Cl. H04L 67/51; G06F 8/41

(52) U.S. Cl. CPC H04L 67/51; G06F 8/43

(57) ABSTRACT

Systems and methods are disclosed that send a first request to a first microservice to evaluate a set of facts with a set of rule conditions. The systems and methods receive a response from the first microservice that identifies one or more triggered rule conditions from the set of rule conditions based on the first microservice evaluating the set of facts with the set of rule conditions. The systems and methods send one or more second requests to one or more second microservices to perform one or more operations that correspond to the one or more triggered rule conditions.

### TECHNICAL FIELD

Aspects of the present disclosure relate to a rules engine in a computer environment, and more particularly, to a distributed system for processing rule conditions and rule consequences.

### BACKGROUND

A rules engine is a software system that executes rules with respect to facts of a computer system stored in the computer system's working memory. A rule is a small piece of code of the form of “when <condition> then <consequence>.” The <condition> is a declarative constraint over part of the working memory, and the <consequence> is a snippet of executable code, written in some programming language. Rules engines may be used in a variety of applications, including business process management, decision support systems, and event-driven architectures.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 is a block diagram that illustrates an example system, according to some embodiments of the present disclosure.

FIG. 2 is a block diagram that illustrates an example system for using separate microservices to process rule conditions and rule consequences, according to some embodiments of the present disclosure.

FIG. 3 is a block diagram that illustrates an example system for using a condition evaluation microservice to evaluate rule conditions and consequence microservices to perform operations based on triggered rule conditions, according to some embodiments of the present disclosure.

FIG. 4 is a diagram that illustrates example condition evaluation microservice request types, according to some embodiments of the present disclosure.

FIG. 5 is a flow diagram of a method 500 for processing rules using a distributed condition microservice and distributed consequence microservices, in accordance with some embodiments of the present disclosure.

FIG. 6 is a block diagram of an example computing device that may perform one or more of the operations described herein, according to some embodiments of the present disclosure.

### DETAILED DESCRIPTION

As discussed above, a rules engine executes rules in the form of “when <condition> then <consequence>.” A conventional rules engine may include a centralized system that integrates both the <condition> evaluation and the <consequence> execution. Unfortunately, this integrated approach limits the rules engine evaluation and execution to a specific programming language dialect that the rules engine supports in its runtime.

The present disclosure provides an approach that distributes the condition evaluation operations and the consequence execution operations into separate microservices. This approach enables a computer system to employ consequence microservices written in various programming languages, and enables the consequence microservices to operate on a serverless computing environment because the consequence microservices do not maintain any state within the services across calls. A serverless computing environment allocates machine resources on demand and does not hold resources in volatile memory. When an application is not in use, no computing resources are allocated to the application. The consequence microservices receive a request, process the request, and send a response back (if required) without persisting any state information. As such, the consequence microservices may be turned off when not in use and do not need to maintain a presence on a server or cloud-based infrastructure.

In turn, the present disclosure provides an approach that improves the operation of a computer system by using microservice-based execution to simplify polyglot rules generation because the consequence execution operations may be written in any programming language that exposes a service endpoint. In addition, the present disclosure provides an improvement to the technological field of rules engines by using distributed microservices to provide a computer system with the flexibility to utilize consequence microservices that are written in various programming languages in cloud-based environments.

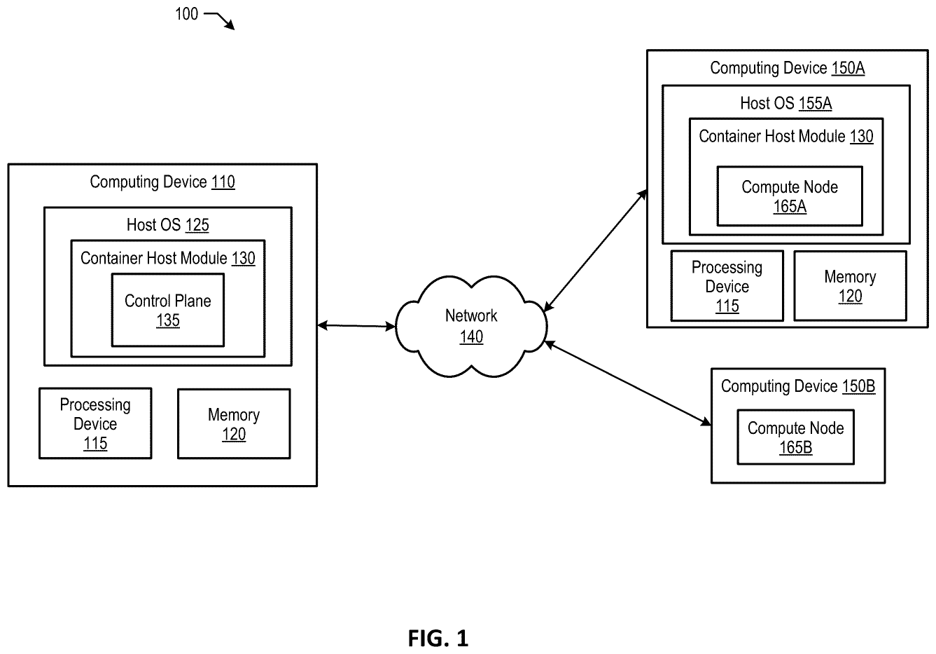

FIG. 1 is a block diagram that illustrates an example system 100. As illustrated in FIG. 1, system 100 includes a computing device 110, and a plurality of computing devices 150 (150A and 150B). The computing devices 110 and 150 may be coupled to each other (e.g., may be operatively coupled, communicatively coupled, may communicate data/messages with each other) via network 140. Network 140 may be a public network (e.g., the Internet), a private network (e.g., a local area network (LAN) or wide area network (WAN)), or a combination thereof. In some embodiments, network 140 may include a wired or a wireless infrastructure, which may be provided by one or more wireless communications systems, such as a WiFi™ hotspot connected with the network 140 and/or a wireless carrier system that can be implemented using various data processing equipment, communication towers (e.g. cell towers), etc. In some embodiments, the network 140 may be an L3 network. The network 140 may carry communications (e.g., data, message, packets, frames, etc.) between computing device 110 and computing devices 150.

Computing devices 110 and 150 may include hardware such as processing device 115 (e.g., processors, central processing units (CPUs)), memory 120 (e.g., random access memory 120 (e.g., RAM)), storage devices (e.g., hard-disk drive (HDD), solid-state drive (SSD), etc.), and other hardware devices (e.g., sound card, video card, etc.). In some embodiments, memory 120 may be a persistent storage that is capable of storing data. A persistent storage may be a local storage unit or a remote storage unit. Persistent storage may be a magnetic storage unit, optical storage unit, solid state storage unit, electronic storage units (main memory), or similar storage unit. Persistent storage may also be a monolithic/single device or a distributed set of devices. Memory 120 may be configured for long-term storage of data and may retain data between power on/off cycles of the computing device 110. Each computing device may include any suitable type of computing device or machine that has a programmable processor including, for example, server computers, desktop computers, laptop computers, tablet computers, smartphones, set-top boxes, etc. In some embodiments, each of the computing devices 110 and 150 may include a single machine or may include multiple interconnected machines (e.g., multiple servers configured in a cluster). The computing devices 110 and 150 may be implemented by a common entity/organization or may be implemented by different entities/organizations. For example, computing device 110 may be operated by a first company/corporation and one or more computing devices 150 may be operated by a second company/corporation. Each of computing device 110 and computing devices 150 may execute or include an operating system (OS) such as host OS 125 and host OS 155A respectively, as discussed in more detail below. The host OS of computing devices 110 and 150 may manage the execution of other components (e.g., software, applications, etc.) and/or may manage access to the hardware (e.g., processors, memory, storage devices etc.) of the computing device. In some embodiments, computing device 110 may implement a control plane (e.g., as part of a container orchestration engine) while computing devices 150 may each implement a compute node (e.g., as part of the container orchestration engine).

In some embodiments, a container orchestration engine 130 (referred to herein as container host 130), such as the Redhat™ OpenShift™ module, may execute on the host OS 125 of computing device 110 and the host OS 155A of computing device 150, as discussed in further detail herein. The container host module 130 may be a platform for developing and running containerized applications and may allow applications and the data centers that support them to expand from just a few machines and applications to thousands of machines that serve millions of clients. Container host 130 may provide an image-based deployment module for creating containers and may store one or more image files for creating container instances. Many application instances can be running in containers on a single host without visibility into each other's processes, files, network, and so on. Each container may provide a single function (often called a “micro-service”) or component of an application, such as a web server or a database, though containers can be used for arbitrary workloads. In this way, the container host 130 provides a function-based architecture of smaller, decoupled units that work together. In some embodiments, computing device 150 may execute on an operational cloud. As discussed herein, one of the containers may provide rule condition evaluations and other containers may provide consequence executions.

Container host 130 may include a storage driver (not shown), such as OverlayFS, to manage the contents of an image file including the read only and writable layers of the image file. The storage driver may be a type of union file system which allows a developer to overlay one file system on top of another. Changes may be recorded in the upper file system, while the lower file system (base image) remains unmodified. In this way, multiple containers may share a file-system image where the base image is read-only media.

An image file may be stored by the container host 130 or a registry server. In some embodiments, the image file may include one or more base layers. An image file may be shared by multiple containers. When the container host 130 creates a new container, it may add a new writable (e.g., in-memory) layer on top of the underlying base layers. However, the underlying image file remains unchanged. Base layers may define the runtime environment as well as the packages and utilities necessary for a containerized application to run. Thus, the base layers of an image file may each comprise static snapshots of the container's configuration and may be read-only layers that are never modified. Any changes (e.g., data to be written by the application running on the container) may be implemented in subsequent (upper) layers such as in-memory layer. Changes made in the in-memory layer may be saved by creating a new layered image.

While the container image is the basic unit containers may be deployed from, the basic units that the container host 130 may work with are referred to as “pods.” In some embodiments, a pod may be one or more containers deployed together on a single host, and the smallest compute unit that can be defined, deployed, and managed. Each pod is allocated its own internal IP address, and therefore may own its entire port space. Containers within pods may share their local storage and networking. In some embodiments, pods have a lifecycle in which they are defined, are assigned to run on a node, and run until their container(s) exit or they are removed based on their policy and exit code. Although a pod may contain more than one container, the pod is the single unit that a user may deploy, scale, and manage. The control plane 135 of the container host 130 may include replication controllers (not shown) that indicate how many pod replicas are required to run at a time and may be used to automatically scale an application to adapt to its current demand.

By their nature, containerized applications are separated from the operating systems where they run and, by extension, their users. The control plane 135 may expose applications to internal and external networks by defining network policies that control communication with containerized applications (e.g., incoming HTTP or HTTPS requests for services inside the cluster 165).

A typical deployment of the container host 130 may include a control plane 135 and a cluster of compute nodes 165, including compute nodes 165A and 165B (also referred to as compute machines). The control plane 135 may include REST APIs which expose objects as well as controllers which read those APIs, apply changes to objects, and report status or write back to objects. The control plane 135 manages workloads on the compute nodes 165 and also executes services that are required to control the compute nodes 165. For example, the control plane 135 may run an API server that validates and configures the data for pods, services, and replication controllers as well as provides a focal point for the cluster 165's shared state. The control plane 135 may also manage the logical aspects of networking and virtual networks. The control plane 135 may further provide a clustered key-value store (not shown) that stores the cluster 165's shared state. The control plane 135 may also monitor the clustered key-value store for changes to objects such as replication, namespace, and service account controller objects, and then enforce the specified state.

The cluster of compute nodes 165 are where the actual workloads requested by users run and are managed. The compute nodes 165 advertise their capacity and a scheduler (not shown), which is part of the control plane 135, determines which compute nodes 165 containers and pods will be started on. Each compute node 165 includes functionality to accept and fulfill requests for running and stopping container workloads, and a service proxy, which manages communication for pods across compute nodes 165. A compute node 165 may be implemented as a virtual server, logical container, or GPU, for example.

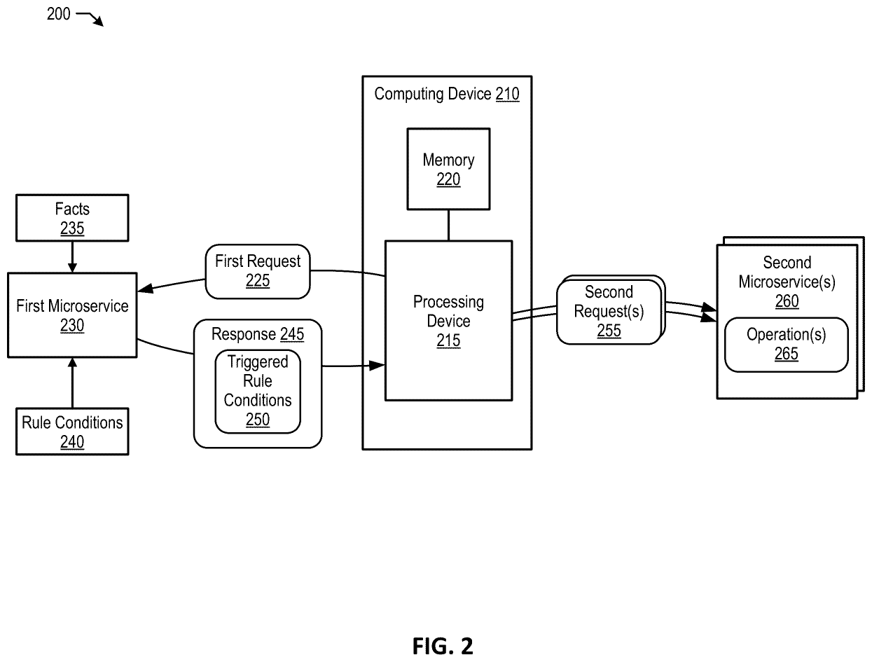

FIG. 2 is a block diagram that illustrates an example system for using separate microservices to process rule conditions and rule consequences, according to some embodiments of the present disclosure.

System 200 includes computing device 210, first microservice 230, and second microservices 260. Computing device 210 includes processing device 215 and memory 220. Processing device 215 sends a first request 225 to a first microservice 230 to evaluate a set of facts 235 with a set of rule conditions 240. For example, processing device 215 may send a message of “POST/<session-id>/evaluate” to first microservice 230, which instructs first microservice 230 to evaluate the rules in rule conditions 240 with facts 235 corresponding to a particular <session-id>.

First microservice 230 evaluates rule conditions 240 with facts 235 and sends response 245 with triggered rule conditions 250 to processing device 215. Triggered rule conditions 250 includes which rule conditions were triggered and information pertaining to the cause of the trigger. For example, triggered rule conditions 250 may include the following:

{
“r1”: [
{ “message”: “hello” }
]
}

Processing device 215 evaluates triggered rule conditions 250 to determine which one or more of second microservices 260 to call. Using the example above, processing devices 215 identifies a consequence microservice (e.g., using a service discovery table) corresponding to rule “r1” to evaluate the consequence of an object of contents “{“message”: “hello” }.”

Processing device 215 identifies the corresponding microservice(s) and sends second requests 255 to second microservices 260 to perform operations 265 that correspond to the triggered rule conditions 250. In some embodiments, second microservices 260 performs operations 265 and may or may not notify processing device 215 of the completion. In some embodiments, second microservices 260 may perform operations 265 such as firing an event, updating a database, inserting or updating new facts into facts 235, notifying a user, adjusting system parameters, modifying system settings, etc. In some embodiments, processing device 215 extracts trigger information from the triggered rule conditions 250 that identifies facts that triggered the triggered rule conditions (e.g., {“message”: “hello” }). In these embodiments, processing device 215 inserts the trigger information into second requests 255 that are sent to the one or more second microservices 260.

In some embodiments, second microservices 260 are stateless and execute on a serverless computing environment. As discussed above, a serverless computing environment allocates machine resources on demand and does not hold resources in volatile memory. When second microservices 260 are not in use, no computing resources are allocated to the second microservices 260. The second microservices 260 receive second requests 255, process the requests, and send a response back (if required) without persisting any state information.

In some embodiments, processing device 215 identifies rules included in the trigger information, and selects second microservices 260 by matching the rules to second microservices 260 in a service discovery table. In some embodiments, second microservices 260 include a first consequence microservice written in a first programming language and a second consequence microservice written in a second programming language.

In some embodiments, processing device 215 invokes a first instantiation of a second microservice 260 to perform a first operation, and invokes a second instantiation of a second microservice 260 to perform a second operation.

In some embodiments, computing device 210 is a client acting as an intermediary between first microservice 230 and the one or more second microservices 260. In these embodiments, the client is a destination of response 245 from first microservice 230, and the client is a source of second requests 255 to second microservices 260. In some embodiments, computing device 210, first microservice 230, and second microservices 260 all execute on different cloud-based environments. In some embodiments, first microservice 230 is unaware of second microservices 260, and vice versa.

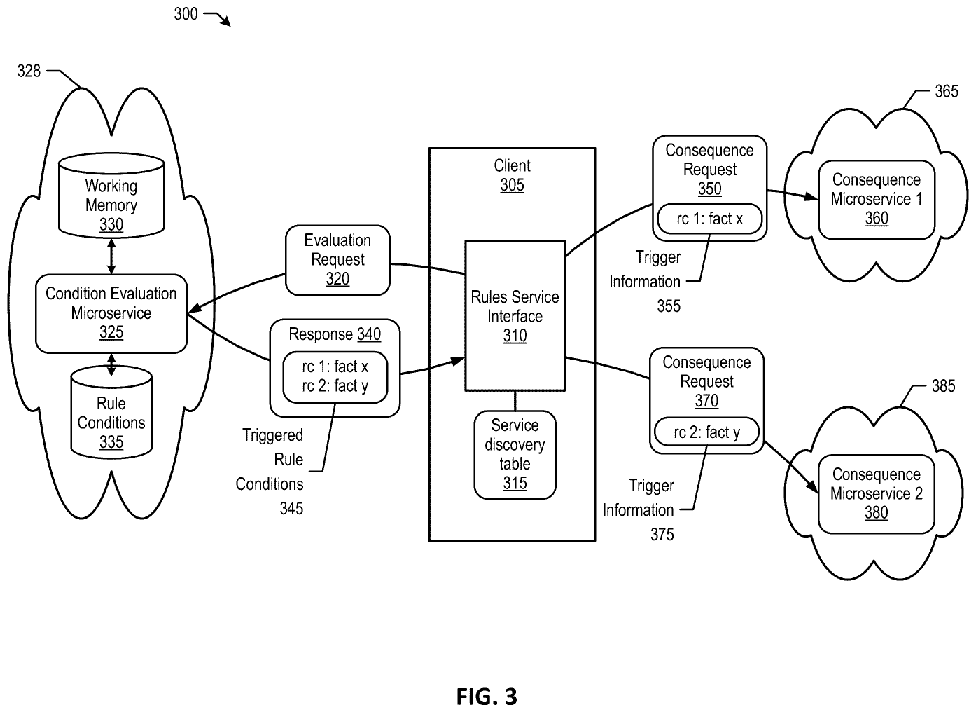

FIG. 3 is a block diagram that illustrates an example system for using a condition evaluation microservice to evaluate rule conditions and consequence microservices to perform operations based on triggered rule conditions, according to some embodiments of the present disclosure.

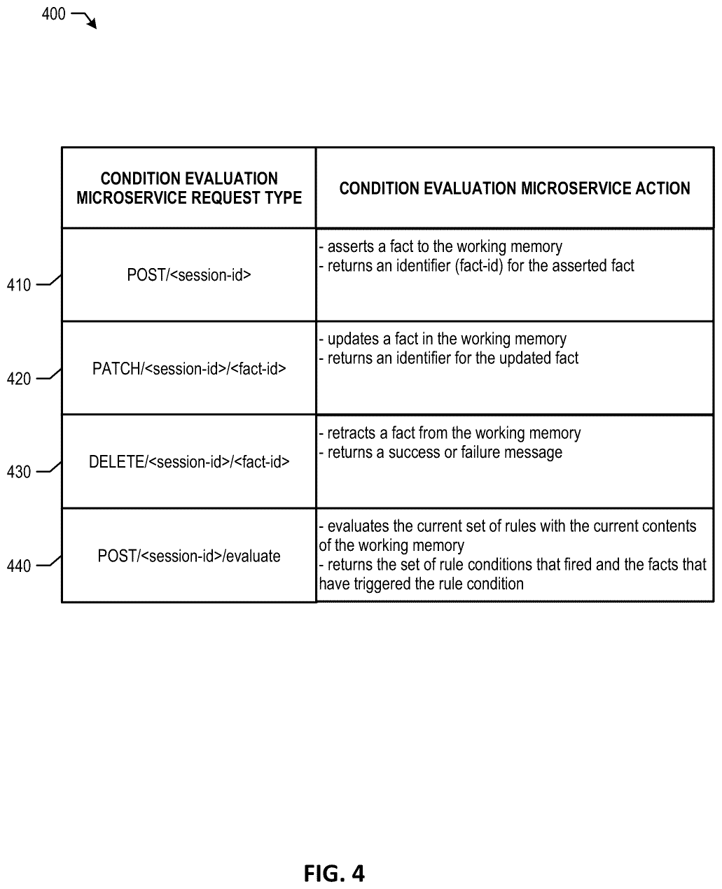

System 300 includes client 305. Client 305 includes rules service interface 310, which receives and processes system triggers (e.g., when a sensor does not provide information within a particular time, scheduled maintenance, etc.). When rules service interface 310 receives a trigger, rules service interface 310 sends evaluation request 320 to condition evaluation microservice 325. For example, if condition evaluation microservice 325 is an HTTP based microservice, rules service interface 310 may send a “POST/<session-id>/evaluate” message to condition evaluation microservice 325 (see FIG. 4 and corresponding text for further details).

Condition evaluation microservice 325 couples to working memory 330 and rule conditions 335. In one embodiment, condition evaluation microservice 325 is encapsulated in a containerized microservice and is located in cloud environment 328. Condition evaluation microservice 325 evaluates rule conditions in rule conditions 335 with facts included in working memory 330 to determine if there are any trigger conditions, such as whether the facts indicate a threshold has been exceeded.

When condition evaluation microservice 325 completes the evaluation, condition evaluation microservice 325 sends response 340 back to rule service interface 310. Response 340 includes triggered rule conditions 345, which identifies rule conditions that have been triggered along with relevant facts. FIG. 3 shows that response 340 indicates that rule condition 1 and rule condition 2 were triggered based on fact X and fact Y, respectively. In some embodiments, rules service interface 310 accesses service discovery table 315 to identify which consequence microservices correspond to rule conditions 1 and 2. In some embodiments, rules service interface 310 queries a service, such as Kubernetes™, to query multiple instances of a microservice.

Rules service interface 310, based on service discovery table 315 (or an external service), sends consequence request 350 to consequence microservice 1 360 (corresponds to rule condition 1) operating in cloud environment 365, and sends consequence request 370 to consequence microservice 2 380 (corresponds to rule condition 2) operating in cloud environment 385. Consequence request 350 includes trigger information 355, which consequence microservice 1 360 may use to perform an operation. Consequence request 370 includes trigger information 375, which consequence microservice 2 380 may user to perform an operation.

In some embodiments, condition evaluation microservices 325, consequence microservice 1 360, consequence microservice 2 380, and rules service interface 310 are written in one or more different programming languages. In some embodiments, multiple instances of consequence microservices 1 360 or 2 380 maybe instantiated based on which rules have been triggered. In turn, condition evaluation microservice 325 operates independently from consequences microservice 1 360 and consequence microservice 2 380.

In some embodiments, when consequence microservices 360/380 performs their operations, the operations may cause new facts to be inserted into working memory 330. The new facts may trigger other rule conditions, which triggers subsequent consequence requests to be sent to other consequence microservices. In these embodiments, the process continues until a fixed point is reached.

FIG. 4 is a diagram that illustrates example condition evaluation microservice request types, according to some embodiments of the present disclosure. Table 400 includes four microservice request types. Rows 410, 420, and 430 include request types for managing facts and working memory 330. When rules service interface 310 wishes to add a fact (e.g., scheduled system measurements, system anomalies, etc.) system to working memory 330, rules service interface 310 sends “POST/<session-id> to condition evaluation microservice 325. In turn, condition evaluation microservice 325 returns a fact identifier (<fact-id>) for rule service interface 310 to reference in subsequent updates or deletions (see below).

In some embodiments, <session-id> is an identifier of a current “session,” such as when a system instantiates several sessions for the same rule base and session-id is a mechanism to identify the corresponding working memory. For example, rules may exist about “Persons,” and session #1 includes information about “Paul” and “John,” while session #2 info about “Ringo.” In this example, a fact is sent as a body of the request to those addresses:

POST /1
BODY:
{ “type”: “Person”,
“name: “Paul” }

When rules service interface 310 wishes to update a fact in working memory 330, rules service interface 310 sends “PATCH/<session-id>/<fact-id> to condition evaluation microservice 325, which updates the fact <fact-id> in the corresponding session <session-id>.

When rules service interface 310 wishes to send a message to condition evaluation microservice 325 to delete a fact, rules service interface 310 sends a message in the format of “DELETE/<session-id>/<fact-id>,” which deletes the fact <fact-id> in the corresponding session <session-id>.

When rules service interface 310 wishes to request the evaluation service to evaluate the rules with the working memory, rules service interface 310 sends “POST/<session-id>/evaluate,” which instructs rules service interface 310 to evaluate the rules with facts corresponding to the particular <session-id>.

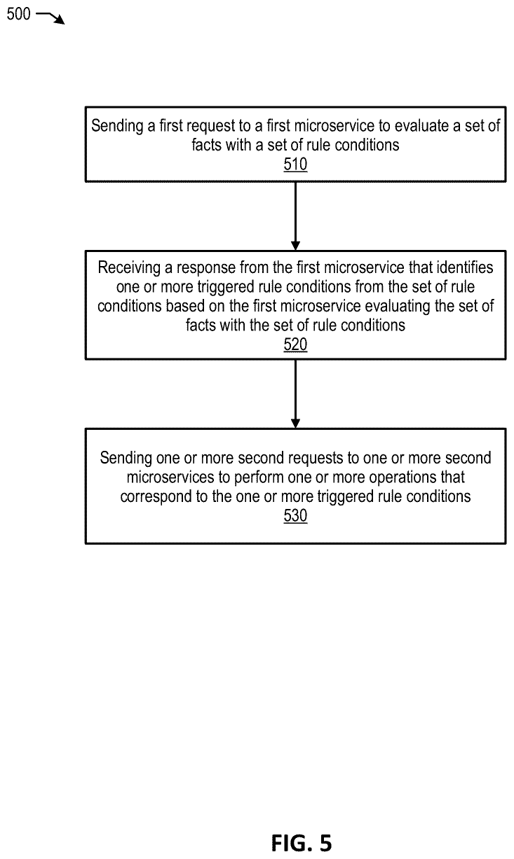

FIG. 5 is a flow diagram of a method 500 for processing rules using a distributed condition microservice and distributed consequence microservices, in accordance with some embodiments of the present disclosure. Method 500 may be performed by processing logic that may include hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. In some embodiments, at least a portion of method 500 may be performed by processing device 115 shown in FIG. 1.

With reference to FIG. 5, method 500 illustrates example functions used by various embodiments. Although specific function blocks (“blocks”) are disclosed in method 500, such blocks are examples. That is, embodiments are well suited to performing various other blocks or variations of the blocks recited in method 500. It is appreciated that the blocks in method 500 may be performed in an order different than presented, and that not all of the blocks in method 500 may be performed.

With reference to FIGS. 5, method 500 begins at block 510, where processing logic sends a first request to a first microservice to evaluate a set of facts with a set of rule conditions. For example, the processing logic may send a message of “POST/<session-id>/evaluate” to the first microservice to evaluate a set of facts with a set of rule conditions corresponding to a particular session.

At block 520, processing logic receives a response from the first microservice that identifies one or more triggered rule conditions from the set of rule conditions based on the first microservice evaluating the set of facts with the set of rule conditions. For example, the processing logic may receive a response that identifies a rule that was triggered (e.g., “rule 2”) and information corresponding to the triggered rule condition (e.g., {“person”: “paul” }).

At block 530, processing logic sends one or more second requests to one or more second microservices to perform one or more operations that correspond to the one or more triggered rule conditions. In some embodiments, the processing logic uses a service directory table or external service to identify the consequence microservice that corresponds to the triggered rule condition. In some embodiments, the processing logic extracts trigger information from the response and inserts the trigger information into the second request that is sent to the one or more microservices.

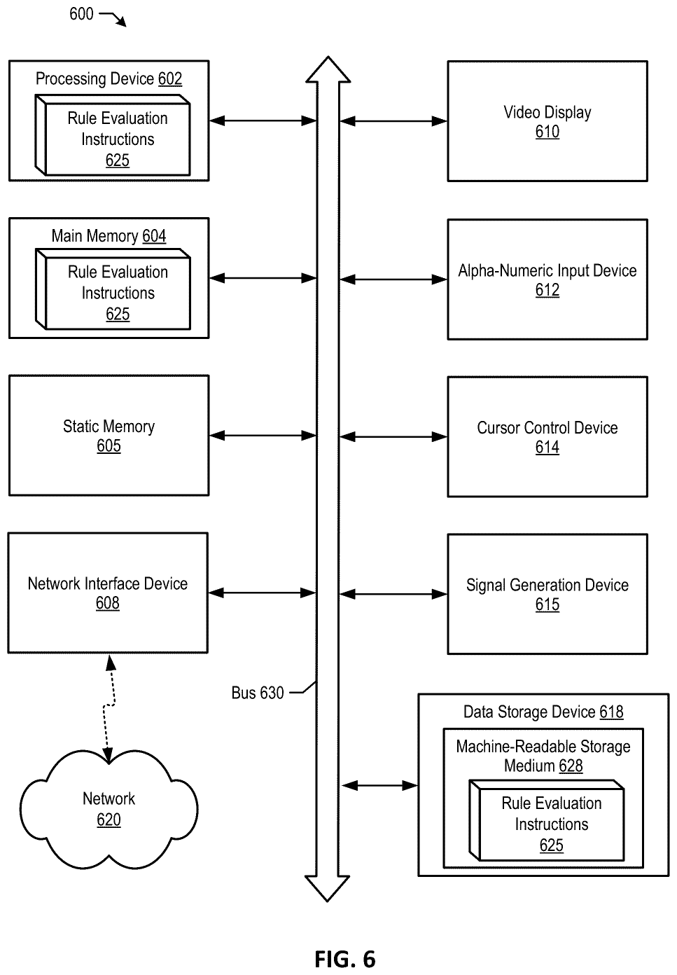

FIG. 6 illustrates a diagrammatic representation of a machine in the example form of a computer system 600 within which a set of instructions, for causing the machine to perform any one or more of the methodologies discussed herein for intelligently scheduling containers.

In alternative embodiments, the machine may be connected (e.g., networked) to other machines in a local area network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, a switch or bridge, a hub, an access point, a network access control device, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. In some embodiments, computer system 600 may be representative of a server.

The exemplary computer system 600 includes a processing device 602, a main memory 604 (e.g., read-only memory (ROM), flash memory, dynamic random access memory (DRAM), a static memory 606 (e.g., flash memory, static random access memory (SRAM), etc.), and a data storage device 618 which communicate with each other via a bus 630. Any of the signals provided over various buses described herein may be time multiplexed with other signals and provided over one or more common buses. Additionally, the interconnection between circuit components or blocks may be shown as buses or as single signal lines. Each of the buses may alternatively be one or more single signal lines and each of the single signal lines may alternatively be buses.

Computing device 600 may further include a network interface device 608 which may communicate with a network 620. The computing device 600 also may include a video display unit 610 (e.g., a liquid crystal display (LCD) or a cathode ray tube (CRT)), an alphanumeric input device 612 (e.g., a keyboard), a cursor control device 614 (e.g., a mouse) and an acoustic signal generation device 616 (e.g., a speaker). In some embodiments, video display unit 610, alphanumeric input device 612, and cursor control device 614 may be combined into a single component or device (e.g., an LCD touch screen).

Processing device 602 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. Processing device 602 may also be one or more special-purpose processing devices such as an application specific integrated circuit (ASIC), a field programmable gate array (FPGA), a digital signal processor (DSP), network processor, or the like. The processing device 602 is configured to execute rule evaluation instructions 625, for performing the operations and steps discussed herein.

The data storage device 618 may include a machine-readable storage medium 628, on which is stored one or more sets of rule evaluation instructions 625 (e.g., software) embodying any one or more of the methodologies of functions described herein. The rule evaluation instructions 625 may also reside, completely or at least partially, within the main memory 604 or within the processing device 602 during execution thereof by the computer system 600; the main memory 604 and the processing device 602 also constituting machine-readable storage media. The rule evaluation instructions 625 may further be transmitted or received over a network 620 via the network interface device 608.

The machine-readable storage medium 628 may also be used to store instructions to perform a method for intelligently scheduling containers, as described herein. While the machine-readable storage medium 628 is shown in an exemplary embodiment to be a single medium, the term “machine-readable storage medium” should be taken to include a single medium or multiple media (e.g., a centralized or distributed database, or associated caches and servers) that store the one or more sets of instructions. A machine-readable medium includes any mechanism for storing information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read-only memory (ROM); random-access memory (RAM); erasable programmable memory (e.g., EPROM and EEPROM); flash memory; or another type of medium suitable for storing electronic instructions.

Unless specifically stated otherwise, terms such as “receiving,” “routing,” “updating,” “providing,” or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission or display devices. Also, the terms “first,” “second,” “third,” “fourth,” etc., as used herein are meant as labels to distinguish among different elements and may not necessarily have an ordinal meaning according to their numerical designation.

Examples described herein also relate to an apparatus for performing the operations described herein. This apparatus may be specially constructed for the required purposes, or it may comprise a general purpose computing device selectively programmed by a computer program stored in the computing device. Such a computer program may be stored in a computer-readable non-transitory storage medium.

The methods and illustrative examples described herein are not inherently related to any particular computer or other apparatus. Various general purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. 112, sixth paragraph, for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the present disclosure to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the present disclosure is not to be limited to the details given herein, but may be modified within the scope and equivalents of the appended claims.

What is claimed is:

1. A method comprising:
sending a first request to a first microservice executing in a cloud environment, wherein the first request comprises a request type that instructs the first microservice to evaluate a plurality of facts stored in a memory in the cloud environment with a plurality of rule conditions;
receiving a response from the first microservice that comprises a triggered rule condition and at least one fact from the plurality of facts, wherein the triggered rule condition is one of the plurality of rule conditions that was triggered from the at least one fact being stored in the memory;
accessing, by a processing device, a service discovery table to identify a plurality of second microservices that are configured to perform one or more operations corresponding to the triggered rule condition, wherein the plurality of second microservices each operate on a serverless computing environment and are each written in a different programming language;
sending one of a plurality of second requests to each of the plurality of second microservices, wherein the plurality of second requests comprise the triggered rule condition and the at least one fact; and
receiving a response from one of the plurality of second microservices based on the second request sent to the one of the plurality of second microservices.

2. The method of claim 1, further comprising:
performing, by the one of the plurality of second microservices, the one or more operations, wherein the one of the plurality of second microservices are stateless subsequent to performing the one or more operations.

3. (canceled)

4. (canceled)

5. The method of claim 1, wherein the one of the plurality of second microservices comprise a first consequence microservice, and wherein the first consequence microservice is written in a first programming language.

6. The method of claim 5, wherein the method further comprises:
invoking a first instantiation of the first consequence microservice to perform a first one of the one or more operations; and
invoking a second instantiation of the first consequence microservice to perform a second one of the one or more operations.

7. The method of claim 1, wherein the processing device operates on a client that is an intermediary between the first microservice and the one of the plurality of second microservices, the client being a destination of the response from the first microservice, and the client being a source of the plurality of second requests to the plurality of second microservices.

8. A system comprising:
a processing device; and
a memory to store instructions that, when executed by the processing device cause the processing device to:
send a first request to a first microservice executing in a cloud environment, wherein the first request comprises a request type that instructs the first microservice to evaluate a plurality of facts stored in a memory in the cloud environment with a plurality of rule conditions;
receive a response from the first microservice that comprises a triggered rule condition and at least one fact from the plurality of facts, wherein the triggered rule condition is one of the plurality of rule conditions that was triggered from the at least one fact being stored in the memory;
access a service discovery table to identify a plurality of second microservices that are configured to perform one or more operations corresponding to the triggered rule condition, wherein the plurality of second microservices each operate on a serverless computing environment and are each written in a different programming language;
send one of a plurality of second requests to each of the plurality of second microservices, wherein the plurality of second requests comprise the triggered rule condition and the at least one fact; and
receive a response from one of the plurality of second microservices based on the second request sent to the one of the plurality of second microservices.

9. The system of claim 8, wherein the one of the plurality of second microservices are stateless subsequent to performing the one or more operations.

10. (canceled)

11. (canceled)

12. The system of claim 8, wherein the one of the plurality of second microservices comprise a first consequence microservice, and wherein the first consequence microservice is written in a first programming language.

13. The system of claim 12, wherein the processing device, responsive to executing the instructions, further causes the system to:
invoke a first instantiation of the first consequence microservice to perform a first one of the one or more operations; and
invoke a second instantiation of the first consequence microservice to perform a second one of the one or more operations.

14. The system of claim 8, wherein the processing device operates on a client that is intermediary between the first microservice and the one of the plurality of second microservices, the client being a destination of the response from the first microservice, and the client being a source of the plurality of second requests to the plurality of second microservices.

15. A non-transitory computer readable medium, having instructions stored thereon which, when executed by a processing device, cause the processing device to:
send a first request to a first microservice executing in a cloud environment, wherein the first request comprises a request type that instructs the first microservice to evaluate a plurality of facts stored in a memory in the cloud environment with a plurality of rule conditions;
receive a response from the first microservice that comprises a triggered rule condition and at least one fact from the plurality of facts, wherein the triggered rule condition is one of the plurality of rule conditions that was triggered from the at least one fact being stored in the memory;
access, by the processing device, a service discovery table to identify a plurality of second microservices that are configured to perform one or more operations corresponding to the triggered rule condition, wherein the plurality of second microservices each operate on a serverless computing environment and are each written in a different programming language;
send one of a plurality of second requests to each of the plurality of second microservices, wherein the plurality of second requests comprise the triggered rule condition and the at least one fact; and
receive a response from one of the plurality of second microservices based on the second request sent to the one of the plurality of second microservices.

16. The non-transitory computer readable medium of claim 15, wherein the one of the plurality of second microservices are stateless subsequent to performing the one or more operations.

17. (canceled)

18. (canceled)

19. The non-transitory computer readable medium of claim 15, wherein the one of the plurality of second microservices comprise a first consequence microservice, and wherein the first consequence microservice is written in a first programming language.

20. The non-transitory computer readable medium of claim 19, wherein the processing device is to:
invoke a first instantiation of the first consequence microservice to perform a first one of the one or more operations; and
invoke a second instantiation of the first consequence microservice to perform a second one of the one or more operations.
